(19) United States
(12) Patent Application Publication
(10) Pub. No.: US 2017/0154285 A1
(43) Pub. Date: Jun. 1, 2017

(54) COMPUTER-IMPLEMENTED METHOD OF PROCESSING INFORMATION, INFORMATION PROCESSING APPARATUS, AND RECORDING MEDIUM

(71) Applicant: FUJITSU LIMITED, Kawasaki-shi (JP)

(72) Inventors: Hirofumi Inokuchi, Yokohama (JP); Hiroaki Komine, Yamato (JP); Kiyoko TAMURA, Fuchu (JP)

(73) Assignee: FUJITSU LIMITED, Kawasaki-shi (JP)

(21) Appl. No.: 15/359,783

(22) Filed: Nov. 23, 2016

(30) Foreign Application Priority Data
Nov. 27, 2015 (JP) 2015-232324

(51) Int. Cl. G06Q 10/06

(52) U.S. Cl. CPC G06Q 10/0633

(57) ABSTRACT

A computer-implemented method of processing information executed by a processor included in an information processing apparatus, the method includes executing, with the processor, a first workflow including a determination processing to determine whether there is a second workflow to be used after the first workflow; determining whether there is the second workflow in the determination processing; switching from the first workflow to the second workflow by starting the second workflow and terminating the first workflow, when determining that there is the second workflow; and providing the second workflow to a terminal device.

### CROSS-REFERENCE TO RELATED APPLICATION

This application is based upon and claims the benefit of priority of the prior Japanese Patent Application No. 2015-232324, filed on Nov. 27, 2015, the entire contents of which are incorporated herein by reference.

### FIELD

The embodiments discussed herein are related to a computer-implemented method of processing information, an information processing apparatus and a recording medium.

### BACKGROUND

Operational work in a business system is now automated by a workflow. The range of application of such a workflow is not limited to office processing of sales slip, and the like, but is expanded to information technology (IT) operation management. For example, attention is given to Runbook Automation (RBA) techniques that automate processes regarding IT operation management, and the like. As the related art, for example, Japanese Laid-open Patent Publication No. 2005-92544, Japanese Laid-open Patent Publication No. 2002-24037, and the like are disclosed.

However, it is sometimes difficult to smoothly switch old and new workflows by the techniques described above.

In the RBA described above, a workflow having processing defined by repetition processing, a so-called loop processing, is sometimes executed. When a workflow like this is executed, it is not possible to safely stop the workflow in any processing step included in the procedure of the workflow. This is because there are cases where some workflow includes a processing step in which a problem occurs if the processing step is suspended in the middle. For this reason, a system administrator, or the like sometimes has to perform an operation, for example a stop operation of a running workflow in the stage of a processing step in which a problem is unlikely to occur, and further, a start operation of an update workflow after the confirmation is made that the running workflow has been stopped. Such an operation inhibits enabling smooth switching of old and new workflows. In view of the above, it is desirable to enable smooth switching of old and new workflows.

### SUMMARY

According to an aspect of the invention, a computer-implemented method of processing information executed by a processor included in an information processing apparatus, the method includes executing, with the processor, a first workflow including a determination processing to determine whether there is a second workflow to be used after the first workflow; determining whether there is the second workflow in the determination processing; switching from the first workflow to the second workflow by starting the second workflow and terminating the first workflow, when determining that there is the second workflow; and providing the second workflow to a terminal device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of another system coupled to a WF execution server according to a first embodiment;

FIG. 2 is a diagram illustrating an example of an existing workflow;

FIG. 3 is a diagram illustrating an example of a workflow according to the first embodiment;

FIG. 4 is a block diagram illustrating an example of a functional configuration of the WF execution server according to the first embodiment;

FIG. 5 is a diagram illustrating an example of a workflow registration screen;

FIG. 6 is a diagram illustrating an example of a workflow registration screen;

FIG. 7 is a diagram illustrating an example of workflow information;

FIG. 8 is a diagram illustrating an example of a schedule registration screen;

FIG. 9 is a diagram illustrating an example of schedule information;

FIG. 10 is a flowchart illustrating a procedure of switching processing of workflows according to the first embodiment; and

FIG. 11 is a diagram illustrating an example of a hardware configuration of a computer that executes a switching program according to the first embodiment and a second embodiment.

### DESCRIPTION OF EMBODIMENTS

Following, a description will be given of a workflow switching program, a switching method and a switching device according to the present disclosure with reference to the accompanying drawings. The embodiments do not limit the disclosed technique. It is possible to suitably combine each of the embodiments within a range in which no contradictions occur in the processing contents.

### First Embodiment

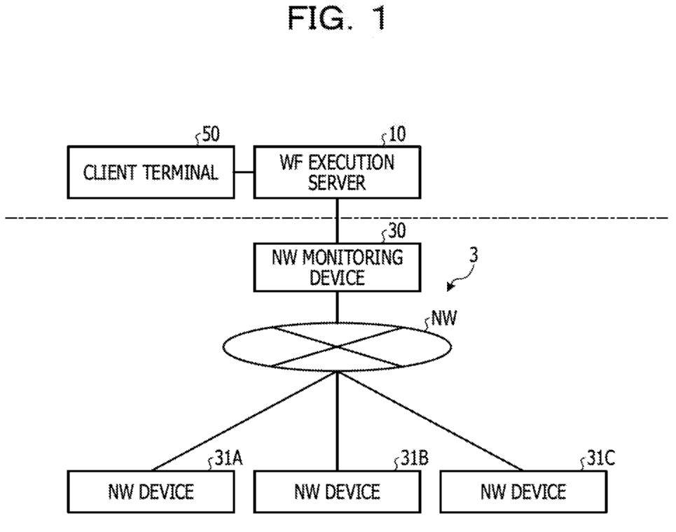

FIG. 1 is a diagram illustrating an example of another system coupled to a workflow (WF) execution server according to a first embodiment. The WF execution server 10 illustrated in FIG. 1 provides WF execution services that execute a workflow in which processes regarding operation management of a network (NW) monitoring system 3 that monitors a network NW are automated.

As part of the WF execution services like these, while the WF execution server 10 is executing a workflow having a procedure including a processing step that determines whether or not there is a new workflow to be used for updating an old workflow, if determined that there is a new workflow, the WF execution server 10 realizes switching processing that starts the new workflow and stops the old workflow. Thereby, the WF execution server smoothly switches old and new workflows as an aspect.

As illustrated in FIG. 1, the WF execution server 10 is coupled to a NW monitoring device 30 that accommodates a plurality of network (NW) devices 31A to 31C. Here, FIG. 1 illustrates an example of the case where three devices, that is to say, a NW device 31A, a NW device 31B and a NW device 31C are accommodated in the NW monitoring device 30. However, this is only one example, and any numbers of NW devices 31 may be accommodated in the NW monitoring device 30. Following, the NW device 31A, the NW device 31B and the NW device 31C are sometimes generically described as a “NW device 31”.

The NW device 31 is a network device that constructs the network NW. It is possible to employ a data transfer device, for example, a router, a switch, or the like for the NW device 31.

The NW monitoring device 30 is a computer that monitors the network NW constructed by the NW device 31.

As an embodiment, it is possible for the NW monitoring device 30 to carry out monitoring of Carrier Ethernet, such as Internet Protocol Virtual Private Network (IP-VPN), Wide Area Ethernet (registered trademark), or the like as an example of the network NW. Further, it is possible for the NW monitoring device 30 to carry out switching of a network configuration, monitoring of an operation state, or the like including bandwidth monitoring as an example of the network NW monitoring. The network NW is not limited to have a network configuration physically constructed by the NW device 31. For example, it is possible for a virtual network that is virtualized by techniques, such as software-defined networking (SDN), network function virtualization (NFV), or the like to become an example of the network NW.

The WF execution server 10 is a computer that provides the WF execution services described above.

As an embodiment, it is possible to implement the WF execution server 10 by installing a WF execution program that realizes the WF execution services described above in a desired computer as package software or online software. For example, the WF execution server 10 may be implemented as a Web server that provides the WF execution services described above. Alternatively, the WF execution server 10 may be implemented as a cloud that provides the WF execution services described above as outsourcing.

A client terminal 50 is a computer that receives the WF execution services described above. The client terminal 50 is used by the person concerned, for example, a network administrator who manages the NW monitoring system 3, or the like.

As an embodiment, a WF setting program for a client, which realizes creation, registration, update, and the like of a workflow to be executed by the WF execution server 10, is installed in the client terminal 50. The WF setting program like this is operated in the client terminal 50 so that the functions as follows are provided. For example, it is possible for the client terminal 50 to provide an environment that allows creation of source code of a workflow through a workflow creation tool to the above-described network administrator, or the like. Here, a workflow to be created according to the present embodiment is a workflow indicating an execution procedure of a plurality of processing steps as an example. A workflow created in the present embodiment is different from an existing workflow in the point that an application programming interface (API) that switches old and new workflows are incorporated in a series of processing steps.

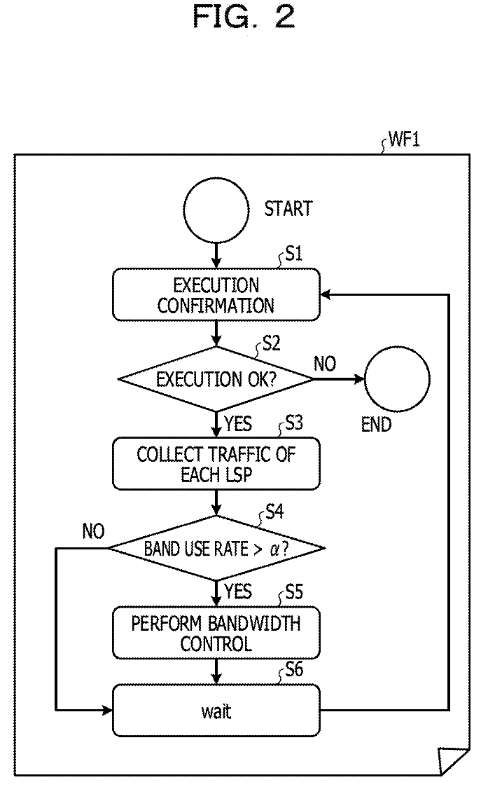

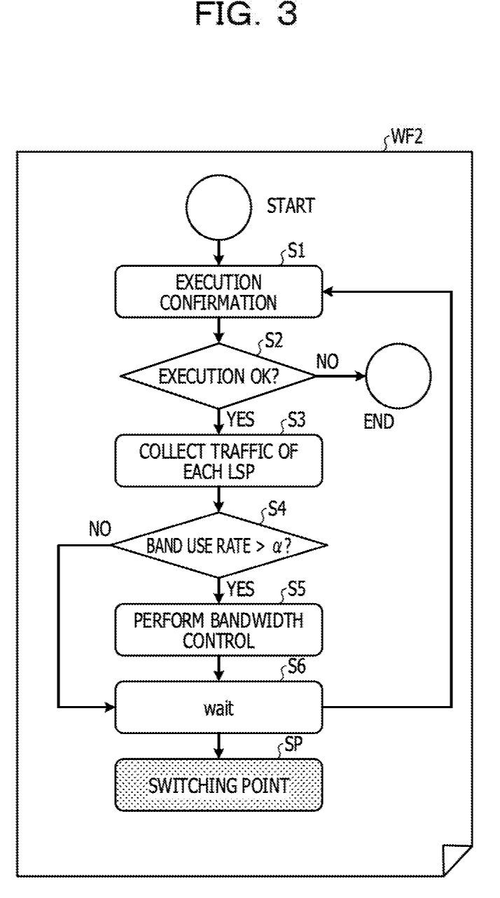

FIG. 2 is a diagram illustrating an example of an existing workflow. FIG. 3 is a diagram illustrating an example of a workflow according to the first embodiment. The workflows WF1 and WF2 illustrated in FIG. 2 and FIG. 3 respectively are both designed to have a function of monitoring the bandwidth of the network NW in common. FIG. 2 and FIG. 3 assume that the network NW is constructed as an optical network, for example. FIG. 2 and FIG. 3 assume that, for example traffic of each Label Switched Path (LSP) set on Optical Transport Network (OTN) to be monitored is subjected to monitoring.

When a specific description is given of this, as illustrated in FIG. 2 and FIG. 3, in the processing step 51 of the workflows WF1 and WF2, an API that performs execution confirmation of the workflow is defined for the NW monitoring device 30 of the NW monitoring system 3, which corresponds to another system as viewed from the WF execution server 10, which is an execution main body of the workflow. Further, in the processing step S2, a branch of the processing corresponding to the response result from the NW monitoring device 30, that is to say, an execution OK or an execution NOT OK, is defined. That is to say, if the execution NOT OK is returned from the NW monitoring device 30 (S2: No), the processing of the workflows WF1 and WF2 is terminated, whereas if the execution OK is returned from the NW monitoring device 30 (S2: Yes), the processing of the processing step S3 is defined to be executed. Further, in the processing step S3, an API that collects the traffic of each LSP set on the above-described OTN from the NW device 31 for the NW monitoring device 30, which is the other system and notifies the collection result to the WF execution server 10 is defined. Further, in the processing step S4, a general-purpose internal API that calculates a ratio of the total value of the traffic of each LSP to the band of the above-described OTN, a so-called band use rate, and a general-purpose internal API that determines whether or not the band use rate exceeds a threshold value α is defined. At this time, if the band use rate exceeds the threshold value α in the processing step S4 (S4: Yes), performing bandwidth control to switch a part of LSP to the other OTN is defined in the processing step S5. After executing the processing step S5 or if the band use rate does not exceeds the threshold value α in the processing step S4 (S4: No), a general-purpose internal API that waits for a predetermined time period is defined in the processing step S6. In the workflows WF1 and WF2, returning to the processing step S1 after waiting in the processing step S6 is defined, and unless the execution NOT OK is returned from the NW monitoring device 30 in the processing step S2, the processing loops.

In this manner, the workflow WF1 and WF2 have the processing steps from S1 to S6 described above in common. However, the workflow WF2 illustrated in FIG. 3 includes a switching point SP that is not incorporated in the workflow WF1 illustrated in FIG. 2. The “switching point SP” mentioned here is an API that determines whether or not there is a new workflow to be used for updating the workflow WF2. If there is a new workflow, as described later, switching processing that starts the new workflow and stops the old workflow, that is to say, the workflow WF2 is executed. The switching point SP like this is set in the place where a problem is unlikely to occur even if the workflow WF2 is stopped by the above-described network administrator, or the like. The place where the problem is unlikely to occur is, for example, a place immediately after a final processing step among a series of processing steps of a workflow. In the workflow WF2 illustrated in FIG. 3, the switching point SP is set immediately after the processing step S6 which is the final processing step of the workflow WF2. Therefore, the problem is unlikely to occur. Another example of the place where the problem is unlikely to occur is a place immediately before an initial processing step among the series of processing steps of the workflow. In the workflow WF2 illustrated in FIG. 3, the switching point SP is to be set immediately before the processing step S1 which is the initial processing step of the workflow WF2. According to this example, the switching procedure is executed before executing the series of processing steps of the workflow. Therefore, the problem is unlikely to occur.

As described above, as exemplified in the workflow WF2 in FIG. 3, by the client terminal 50, the source code of the workflow including the switching point described above is created. Besides, the client terminal 50 compiles the source code of the workflow into a binary file and saves the binary file of the workflow into a predetermined storage area.

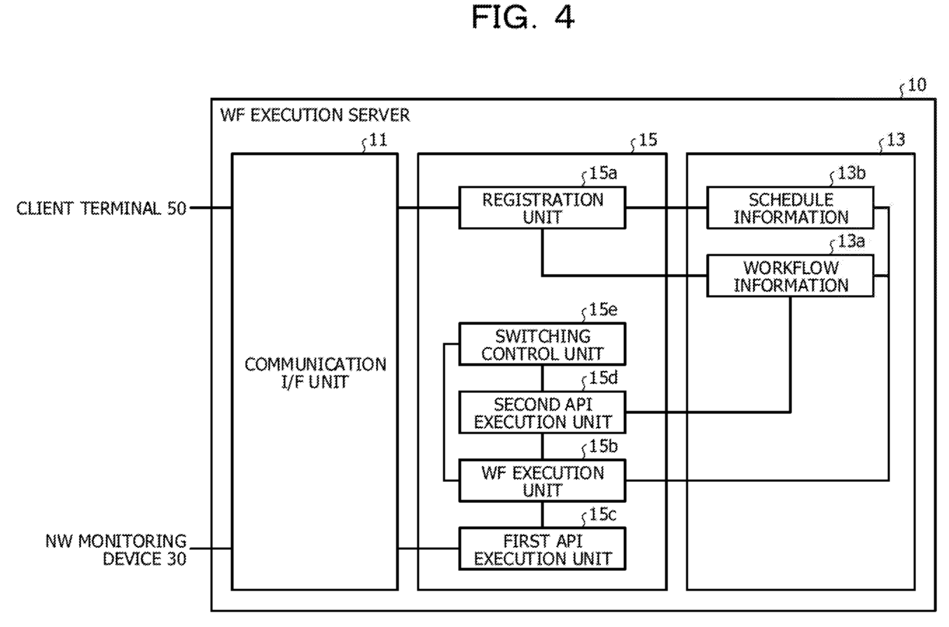

FIG. 4 is a block diagram illustrating an example of a functional configuration of the WF execution server 10 according to the first embodiment. As illustrated in FIG. 4, the WF execution server 10 includes a communication interface (I/F) unit 11, a storage unit 13, and a control unit 15. It does not matter if the server device 10 includes various functional units of a well-known computer, which are other than the functional units illustrated in FIG. 4, for example various input devices, an audio output device, and the like.

The communication I/F unit 11 is an interface that performs communication control with the other devices, for example, the NW monitoring device 30 or the client terminal 50.

As an embodiment, it is possible to employ a network interface card, such as a LAN card, or the like as one mode of the communication I/F unit 11. For example, the communication I/F unit 11 transmits a request of execution confirmation of a workflow and band collection to the NW monitoring device 30, and receives a result of the execution confirmation and the band collection from the NW monitoring device 30. The communication I/F unit 11 receives the attribute information of a workflow and the schedule regarding the execution of the workflow including the workflow from the client terminal 50 and transmits the implementation state of a workflow, or the like to the client terminal 50.

The storage unit 13 is a storage device that stores data used by various programs, such as the above-described WF execution program, or the like including the operating system (OS) executed by the control unit 15.

As an embodiment, it is possible for the storage unit 13 to be implemented as an auxiliary storage device in the WF execution server 10. For example, it is possible to employ a hard disk drive (HDD), an optical disc, a solid state drive (SSD), or the like for the storage unit 13. The storage unit 13 does not have to be implemented as an auxiliary storage device. It is possible for the storage unit 13 to be implemented as a main memory of the WF execution server 10. In this case, it is possible to employ various semiconductor memory elements, for example, a random access memory (RAM) or a flash memory for the storage unit 13.

The storage unit 13 stores workflow information 13a and schedule information 13b as example of data used by the program executed by the control unit 15. In addition to the workflow information 13a and the schedule information 13b, it is possible to store the other electronic data, for example information regarding a vehicle and a driver, a work record, a video record, or the like. Here, a description will be given of the workflow information 13a and the schedule information 13b later when the processing unit that registers the workflow information 13a and the schedule information 13b is described.

The control unit 15 includes an internal memory that stores various programs and control data and executes various kinds of processing by these programs.

As an embodiment, the control unit 15 is implemented as a central processor, that is to say a so-called central processing unit (CPU). The control unit 15 does not have to be implemented as a central processor, and may be implemented as a micro processing unit (MPU). It is possible to realize the control unit 15 by hard-wired logic, such an application specific integrated circuit (ASIC), a field programmable gate array (FPGA), or the like.

The control unit 15 loads the WF execution program that is stored in the storage unit 13 into the work area in the RAM, such as a dynamic random access memory (DRAM), a static random access memory (SRAM), or the like that is implemented as a main memory not illustrated in FIG. 4 so as to virtually realize the processing unit described below. For example, as illustrated in FIG. 4, the control unit 15 includes a registration unit 15a, a WF execution unit 15b, a first API execution unit 15c, a second API execution unit 15d, and a switching control unit 15e.

The registration unit 15a is a processing unit that performs registration of various kinds of information.

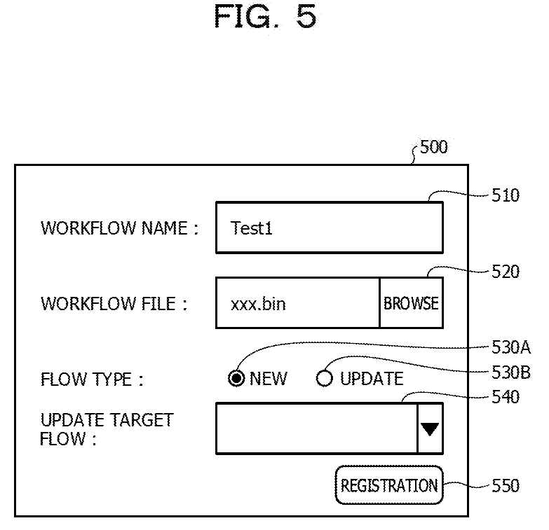

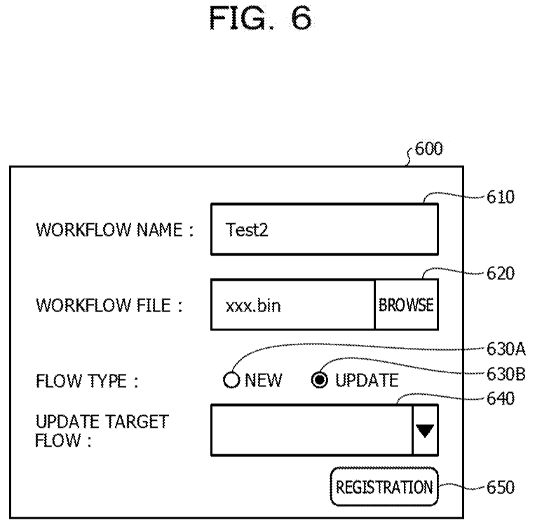

As an embodiment, when the registration unit 15a receives a registration request regarding a workflow created by the client terminal 50, the registration unit 15a displays the registration screens of a workflow illustrated in FIG. 5 and FIG. 6 onto the client terminal 50 as an example.

FIG. 5 and FIG. 6 are diagrams illustrating an example of a workflow registration screen. FIG. 5 illustrates a registration screen when a new workflow is registered. On the other hand, FIG. 6 illustrates a registration screen when a workflow for updating is registered.

Here, as an example, a description will be given of switching of old and new workflows by giving an example of the state in which a network administrator, or the like registers the workflow WF2 illustrated in FIG. 3 as a new workflow “Test1” and then registers a new workflow “Test2” for updating in order to monitor the bandwidth of the network NW. The workflow “Test2” for updating is a workflow in which the threshold value used for comparing with the band use rate at the branch of the processing step S4 of the workflow WF2 is changed from α to β that is a lower value than α in order to change the margin of reducing the concentration of traffic.

As illustrated in FIG. 5, a registration screen 500 includes Graphical User Interface (GUI) components, such as a text box 510, a browse button 520, radio buttons 530A and 530B, a pull-down menu 540, a registration button 550, and the like. Among these, with the text box 510, a text input of “workflow name” is received. With the browse button 520, a folder and a file that are subjected to directory management by the client terminal 50 are referenced. By using this, the binary file of a workflow to be registered in the WF execution server 10 is specified from a directory. With the radio buttons 530A and 530B, the flow type of either “new” or “update” is received alternatively. With the pull-down menu 540, a list of workflows in operation on the WF execution server 10 is displayed. With the pull-down menu 540, a selection of a workflow to be targeted for updating is received from the menu. Here, a description has been given of each GUI component included in the registration screen 500. However, the functions of the GUI components, such as a text box 610, a browse button 620, radio buttons 630A and 630B, a pull-down menu 640, a registration button 650, and the like that are included in a registration screen 600 are the same.

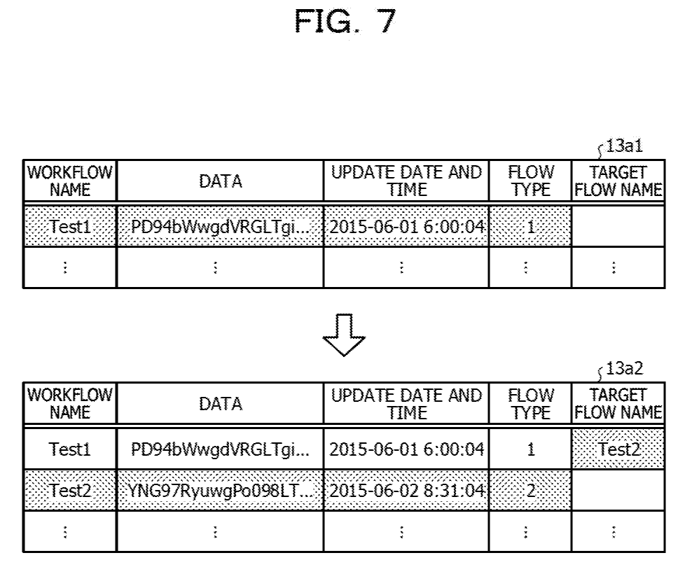

In the environment provided with such GUI components, when a new workflow is registered, as the registration screen 500 illustrated in FIG. 5, a workflow name, a workflow file, and a flow type are specified. That is to say, as illustrated in FIG. 5, “Test1” is input into the text box 510 as the workflow name. As the file name, “xxx.bin” is specified via the browse button 520. The pressing operation of the registration button 550 is received in the state in which “new” is specified as the flow type, that is to say, the state in which the radio button 530A is selected. In this manner, when a new workflow is registered, there is no workflow to be updated. Accordingly, the workflow in operation is not specified in the pull-down menu 540, and the pull-down menu 540 is blank. In this case, in a state in which the workflow to be updated has a NULL value, one record illustrated in the upper part in FIG. 7 is newly registered as workflow information 13a1.

On the other hand, when a workflow for updating is registered, as a registration screen 600 illustrated in FIG. 6, an update target flow is further specified together with a workflow name, a workflow file, and a flow type. That is to say, as illustrated in FIG. 6, “Test2” is input into the text box 610 as a workflow name for updating. As the file name, “xxx.bin” is specified via the browse button 620. As the flow type, “update” is specified. In the state in which “Test1” is specified for the update target flow to be updated, that is to say, the radio button 630B is selected. In the state in which the workflow of the workflow name “Test1” is specified from the workflows in operation, which are displayed in the pull-down menu 640, a pressing operation of the registration button 650 is received. In this manner, when a workflow for updating is registered, a workflow to be updated is also specified. In this case, in the workflow information 13a2 illustrated in the lower part of FIG. 7, a record of the workflow for updating is additionally registered in the second row. The workflow name of the workflow for updating is registered in the field of the target flow of the record corresponding to the workflow for updating in the first row.

FIG. 7 is a diagram illustrating an example of the workflow information 13a. In the upper part of FIG. 7, the workflow information 13a1 including the record of the new workflow “Test1” is registered via the registration screen 500 illustrated in FIG. 5. In the lower part of FIG. 7, the workflow information 13a2 in the stage in which the workflow “Test1” that is registered via the registration screen 500 illustrated in FIG. 5 is set to the workflow to be updated, and the workflow “Test2” for updating is registered via the registration screen 600 illustrated in FIG. 6.

As illustrated in FIG. 7, for the workflow information 13a, it is possible to employ data having the items, such as a workflow name, data, an update date and time, a flow type, a target flow name, and the like in association with one another. The “workflow name” mentioned here indicates the name of a workflow. The “data” indicates the binary file of the workflow. The “registration/update date and time” indicates the date and time when the workflow has been registered or updated. The “flow type” indicates the type of the workflow and the flow type includes “new” and “update”. For example, if the flow type is “new”, “1” is stored in the field. On the other hand, if the flow type is “update”, “2” is stored in the field. The “target flow name” indicates the name of a new workflow to be used for updating the workflow registered in this record. The field of the “target flow name” like this has a NULL value at the initial state, that is to say, at the point in time when a record is newly registered. On the other hand, if the workflow of this record is specified as an update target flow at the time of registration of the workflow for updating, the workflow name for the updating is registered.

When the new workflow “Test1” is registered via the registration screen 500 illustrated in FIG. 5, the record illustrated in the upper part of FIG. 7 is added to the workflow information 13a1. The record illustrated in the upper part of FIG. 7 has the workflow name of “Test1”, its binary file is “PD94bWwgdVRGLTgi . . . ”, and it means that the record was registered at 6:00:04 on Jun. 1, 2015. Further, the record illustrated in the upper part of FIG. 7 has the flow type of “1”, and thus it means that the record is a new workflow at the same time.

When the workflow “Test2” for updating is registered via the registration screen 600 illustrated in FIG. 6, the second record illustrated in the lower part of FIG. 7 is added to the workflow information 13a2. The second record illustrated in the lower part of FIG. 7 has the workflow name of “Test2”, its binary file is “YNG97RyuwgPo098LT . . . ”, and it means that the record was registered at 8:31:04 on Jun. 2, 2015. Further, the second record illustrated in the lower part of FIG. 7 has the flow type of “2”, and that it means that the record is a workflow for updating at the same time. In this manner, the second record illustrated in the lower part of FIG. 7 is added to the workflow for updating. The update workflow name of “Test2” is registered in the field of the target flow of the workflow, “Test1”, which was specified at registration time of the workflow for updating. In this manner, by registering the workflow name of “Test2” to be used for updating the workflow name “Test1” in the field of the target flow of the workflow name “Test1”, which is in operation by the WF execution server 10, it is possible to associate the old and new workflows.

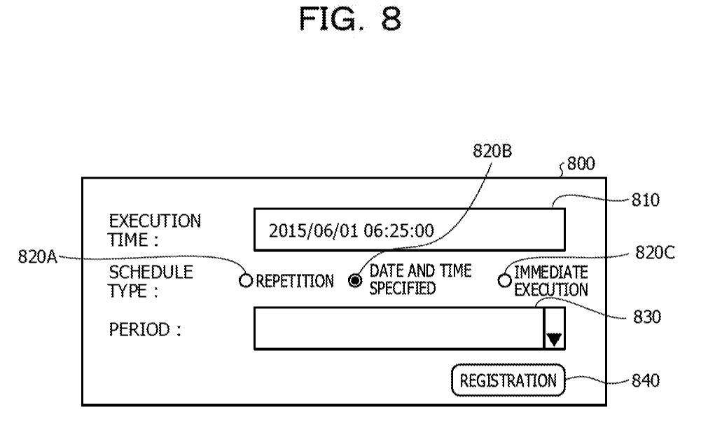

In addition to the registration of the workflow information 13a like this, the registration unit 15a also registers a schedule regarding a workflow. For example, when a new workflow is registered as the workflow information 13a on the client terminal 50, the registration unit 15a displays a schedule registration screen 800 illustrated in FIG. 8 to the client terminal 50 as an example.

FIG. 8 is a diagram illustrating an example of the schedule registration screen. FIG. 8 illustrates a case where a schedule regarding the workflow “Test1” that has been registered via the workflow registration screen 500 illustrated in FIG. 5 is registered. As illustrated in FIG. 8, the registration screen 800 includes GUI components, such as a text box 810, radio buttons 820A to 820C, a pull-down menu 830, a registration button 840, and the like. Among these, with the text box 810, a text input of the date and time when the execution of a workflow is started is received. Here, an example in which the execution time is input through the text box 810 is illustrated. However, a pull-down menu capable of selecting date, hours, minutes, and seconds may be used, and it is possible to use the other GUI components instead as a matter of course. With the radio buttons 820A to 820C, any one of the schedule types, namely “repetition”, “date and time specified” or “immediate execution” is received. Among these, if “repetition” is specified, a schedule for repeatedly executing the workflow is set. If “date and time specified” is specified, a schedule for executing the workflow at a specified date and time is set. If “immediate execution” is specified, when the schedule information 13b of a workflow is registered, a schedule for executing the workflow at the same time is set. With the pull-down menu 830, a selection of a period of causing the WF execution server 10 to execute the workflow is received. For example, the pull-down menu 830 is provided with options, such as “daily”, “weekly”, “monthly”, “every hour”, “every two hours”, “every three hours”, “every four hours”, “every six hours”, “every eight hours”, “every 12 hours”, or the like. It is possible to select a period from these options.

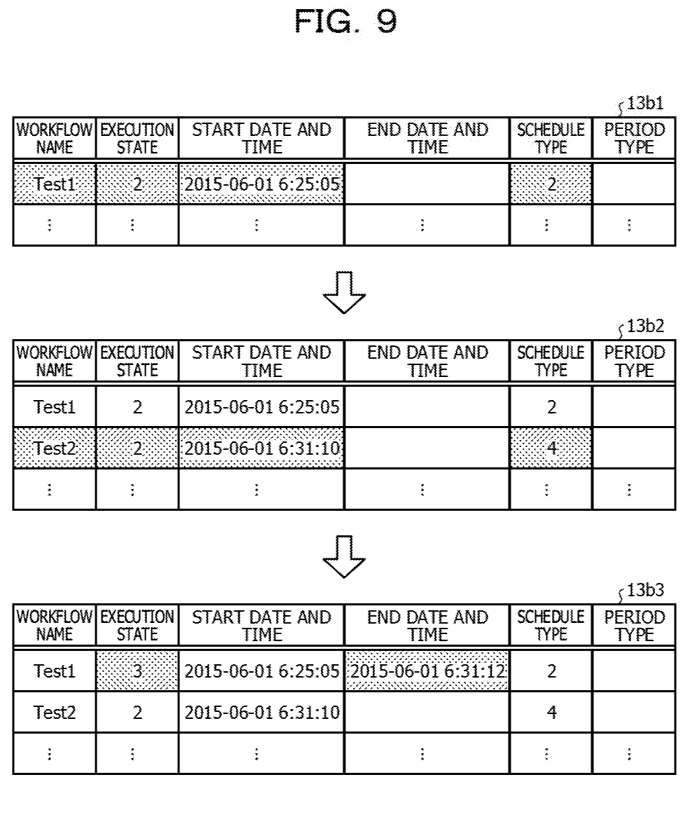

In the environment provided with the GUI components like these, if a schedule for the new workflow “Test1” is registered, as the registration screen 800 illustrated in FIG. 8, the execution time, the schedule type, and the period are specified as an example. That is to say, in the example in FIG. 8, “2015/06/01 06:25:00” is input into the text box 810 as the execution time. In the state in which “date and time specified” is specified for the schedule type, that is to say, in the state in which the radio button 820B is selected, the pressing operation of the registration button 840 is received. In this case, one record illustrated in the upper part of FIG. 9 is newly registered as the schedule information 13b1.

FIG. 9 is a diagram illustrating an example of the schedule information 13b. In the upper part of FIG. 9, the schedule information 13b1 including a record in which a schedule regarding the new workflow “Test1” is registered via the registration screen 800 illustrated in FIG. 8 is illustrated. In the middle part of FIG. 9, the schedule 13b2 at the time when a schedule regarding the workflow “Test2” for updating is registered is illustrated. In the lower part of FIG. 9, the schedule 13b3 after the old and new workflows are switched from the new workflow “Test1” to the workflow “Test2” for updating is illustrated. The detailed description will be given later of the schedule information 13b2 and 13b3 illustrated in the middle part and the lower part of FIG. 9.

As illustrated in FIG. 9, for the schedule information 13b, it is possible to employ data having items, such as a workflow name, an implementation state, a start date and time, an end date and time, a schedule type, a period type, and the like. The “implementation state” indicates a classification of the state in which the workflow is implemented. The “execution state” is, for example unexecuted, in operation, normal end, abort end, abnormal end, and the like. For example, if the implementation state is “unexecuted”, “1” is stored in the field. If the implementation state is “in operation”, “2” is stored in the field. If the implementation state is “normal end”, “3” is stored in the field. If the implementation state is “abort end”, “4” is stored in the field. If the implementation state is “abnormal end”, “5” is stored in the field. The “start date and time” indicates the date and time when the execution of the workflow is started. The “end date and time” indicates the date and time when the execution of the workflow is ended. Further, the “schedule type” indicates the type of the schedule for implementing the workflow. The “schedule type” is the classification, such as, repetition, date and time specified, immediately, update, or the like. For example, if the schedule type is “repetition”, “1” is stored in the field. If the schedule type is “date and time specified”, “2” is stored in the field. If the schedule type is “immediately”, “3” is stored in the field. The “update” is different from the schedule type set for the new workflow, and is automatically set for the workflow for updating. The “update” is automatically set at the time of switching the old and new workflows in order to take over the schedule type set for the update target workflow to which the workflow for updating is applied. In this case, “4” is stored in the field.

For example, if a schedule regarding the new workflow “Test1” is registered via the registration screen 800 illustrated in FIG. 8, the record illustrated in the upper part of FIG. 9 is added to the schedule information 13b1. The record illustrated in the upper part of FIG. 9 has the workflow name of “Test1”, has a schedule for starting execution at 6:25:05 on Jun. 1, 2015, and it means that the workflow is currently in operation. As illustrated in FIG. 3, a period type is not set for the workflow “Test1”.

The WF execution unit 15b is a processing unit that executes a workflow.

As an embodiment, the WF execution unit 15b starts execution of the workflow that meets the condition of the schedule defined by the schedule information 13b out of the workflows included in the workflow information 13a stored in the storage unit 13. For example, the WF execution unit 15b starts execution of a workflow corresponding to the record having the implementation state of “unexecuted” and the schedule type of “immediately” out of the records included in the schedule information 13b. The WF execution unit 15b starts execution of a workflow corresponding to the record having the implementation state of “unexecuted”, the schedule type of “date and time specified”, and having the reference date and time of the schedule information 13b, which has reached the start date and time out of the records included in the schedule information 13b. In addition, the WF execution unit 15b starts execution of a workflow corresponding to the record having the implementation state of “normal end”, the schedule type of “repetition”, and having the period set in the period type, which has passed from the previous execution of the workflow out of the records included in the schedule information 13b.

Here, when execution of a workflow is started, the WF execution unit 15b reads the record of which execution has been identified to be started from the schedule information 13b out of the records included in the workflow information 13a stored in the storage unit 13. The WF execution unit 15b converts the binary file of the workflow included in the record read in advance into the eXtensible Markup Language (XML) format, and loads the record into the internal memory not illustrated in FIG. 4. Besides, the WF execution unit 15b interprets the workflow loaded in the internal memory, and executes the processing corresponding to each processing step in accordance with the procedure defined for the workflow. For example, if the processing step to be executed is an API regarding another system, such as the NW monitoring device 30 of the NW monitoring system 3, or the like, the WF execution unit 15b requests the first API execution unit 15c to execute the API. If the processing step to be executed is a general-purpose internal API, such as four arithmetic operations, or the like or a switching point API, the WF execution unit 15b requests the second API execution unit 15d to execute the API.

The first API execution unit 15c is a processing unit that executes an API regarding another system.

As an embodiment, when the WF execution unit 15b requests the first API execution unit 15c to execute the API regarding another system, the first API execution unit 15c executes the API. For example, if an example of the workflow “Test1” is given, the first API execution unit 15c performs execution confirmation of the workflow on the NW monitoring device 30 in accordance with the definition of the processing step S1. Alternatively, the first API execution unit 15c collects the traffic of each LSP set on the above-described OTN from the NW device 31 in accordance with the definition of the processing step S3, and notifies the collection result.

The second API execution unit 15d is a processing unit that executes the general-purpose internal API and the switching point API.

As an aspect, when the WF execution unit 15b requests the second API execution unit 15d to execute the general-purpose internal API, the second API execution unit 15d executes the API. For example, if an example of the workflow “Test1” is given, the second API execution unit 15d calculates the band use rate on the above-described OTN in accordance with the definition of the processing step S4 and determines whether or not the band use rate exceeds the threshold value α. Alternatively, the second API execution unit 15d performs the bandwidth control to switch a part of the LSP in the above-described OTN to another OTN in accordance with the definition of the processing step S5.

As another aspect, when the WF execution unit 15b requests the second API execution unit 15d to execute the API of the switching point, the second API execution unit 15d performs the following processing. That is to say, the second API execution unit 15d determines whether or not the field of the target flow name of the record corresponding to the workflow in operation has a value other than a NULL value out of the records included in the workflow information 13a.

Here, if the field of the target flow name has a NULL value, it is understood that a new workflow to be used for updating the workflow in operation is not registered. For example, it is assumed that in a state in which the workflow “Test1” is in operation in accordance with the schedule information 13b1 illustrated in the upper part of FIG. 9, the field of the target flow name of the workflow information 13a1 illustrated in FIG. 7 is referenced. In this case, the field of the target flow name has a NULL value. Accordingly, it is understood that the workflow that updates the workflow “Test1” in operation is not registered at this stage.

On the other hand, if a value other than a NULL value is registered in the field of the target flow name, it is understood that a new workflow to be used for updating the workflow in operation is registered. For example, it is assumed that in the state in which the workflow “Test1” is in operation in accordance with the schedule information 13b1 illustrated in the upper part of FIG. 9, the field of the target flow name of the workflow information 13a2 illustrated in FIG. 7 is referenced. In this case, the field of the target flow name does not have a NULL value. Accordingly, it is understood that a workflow to be used for updating the workflow “Test1”, which is in operation, is registered.

In this manner, if a new workflow to be used for updating the workflow in operation is registered, the second API execution unit 15d determines whether or not there is a record corresponding to the workflow name stored in the field of the target flow name of the record held by the workflow in operation in the workflow information 13a. At this time, if there is a record corresponding to the workflow name stored in the field of the target flow name of the record held by the workflow in operation in the workflow information 13a, it is understood that switching preparation of the old and new workflow has been prepared. On the other hand, if there is not a record corresponding to the workflow name stored in the field of the target flow name of the record held by the workflow in operation in the workflow information 13a, it is understood that the information regarding the new workflow is artificially, logically, or physically corrupted, and switching preparation of the old and new workflows has not been prepared.

The switching control unit 15e is a processing unit that performs switching control of the old and new workflows.

As an embodiment, if there is a record corresponding to the workflow name stored in the field of the target flow name of the record held by the workflow in operation in the workflow information 13a, that is to say, if the switching preparation of the old and new workflows has been prepared, the switching control unit 15e performs the following processing. That is to say, the switching control unit 15e notifies the stopping of the workflow in operation and starting the workflow for updating, that is to say, the switching instruction of the old and new workflows to the WF execution unit 15b. For example, in the example of the workflow information 13a2 illustrated in FIG. 7, an instruction is given to stop the workflow “Test1”, which is in operation, and to start the workflow “Test2” for updating.

The WF execution unit 15b that has received the switching instruction automatically registers the new workflow, that is to say, the schedule of the workflow for updating in the schedule information 13b. For example, as the schedule information 13b2 illustrated in the middle part of FIG. 9, values are stored in the fields, such as a workflow name, an implementation state, a start date and time, a schedule type, and the like that are corresponding to the new workflow. In this manner, if the schedule type of the workflow for updating is registered, update, that is to say, “4” is stored in the field.

After that, the WF execution unit 15b reads out the record of a new workflow out of the records included in the workflow information 13a stored in the storage unit 13. Next, the WF execution unit 15b converts the binary file of the new workflow included in the record that has been read in advance into the XML format, then loads the file in the internal memory not illustrated in FIG. 4 so as to start the workflow for updating. At the same time with this or about that time, the WF execution unit 15b stops the workflow that is to be replaced by the workflow for updating, that is to say, the old workflow. Based on this, WF execution unit 15b updates the contents of the record corresponding to the old workflow out of the schedule information 13b stored in the storage unit 13. For example, when the old workflow “Test1” is stopped, as the schedule information 13b3 illustrated in the lower part of FIG. 9, normal end, that is to say “3” is stored in the field of the implementation state. A value is stored in the field of the end date and time, which had a NULL value. With this operation, switching of the old and new workflows is terminated.

As described above, in the present embodiment, if determined that there is a new workflow while executing a workflow including a switching point API that determines whether or not there is a new workflow to be used for updating an old workflow, a new workflow is started and an old workflow is stopped. Accordingly, when a workflow in which repetition processing, namely a so-called loop processing is defined is executed, it is possible to reduce the occurrence of the operation by a system administrator, or the like to stop the workflow in operation at the stage of the processing step in which a problem is unlikely to occur, and further, to reduce the operation to confirm the stop of the workflow in operation and then to start the workflow for updating. Further, if stopping the old workflow is carried out later than the starting a new workflow, it is possible to remove the time difference from stopping the old workflow to starting a new workflow.

Thereby, it is possible to smoothly switch old and new workflows with this embodiment. In addition, the operation by a network administrator, or the like become unused, and the non-stop operation of the system to be monitored is realized so that it is possible to smoothly carry out a logic change, such as changing the threshold value of bandwidth monitoring in the network monitoring.

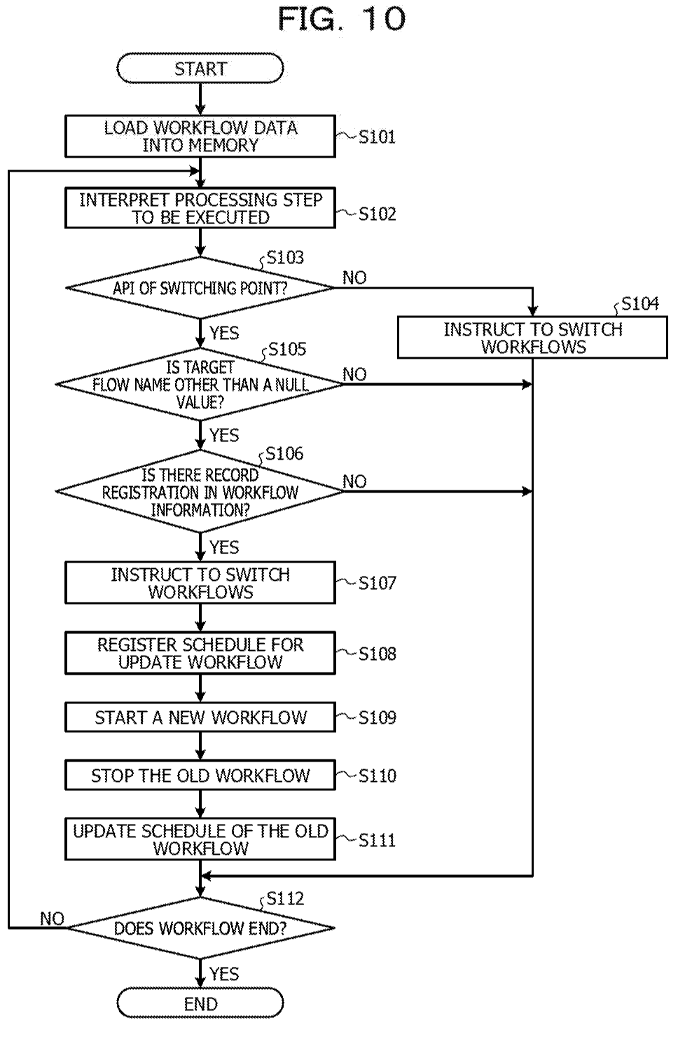

FIG. 10 is a flowchart illustrating a procedure of switching processing of workflows according to the first embodiment. This processing is started when the execution of the workflow included in the workflow information 13a stored in the storage unit 13 is started.

As illustrated in FIG. 10, the WF execution unit 15b converts the binary file of the workflow to be executed from the workflow information 13a into the XML format and loads the workflow into the internal memory not illustrated in FIG. 4 (step S101). Next, the WF execution unit 15b interprets the processing step to be executed in accordance with the procedure defined in the workflow (step S102).

If the processing step to be executed is other than an API of the switching point (step S103 No), the first API execution unit 15c or the second API execution unit 15d executes an API regarding another system or a general-purpose internal API (step S104).

On the other hand, if the processing step to be executed is an API of the switching point (step S103 Yes), the second API execution unit 15d determines whether or not the field of the target flow name of the record corresponding to the workflow in operation out of the records included in the workflow information 13a has a value other than a NULL value (step S105).

At this time, if a value other than a NULL value is registered in the field of the target flow name (step S105 Yes), it is understood that a new workflow to be used for updating the workflow in operation is registered. In this case, the second API execution unit 15d further determines whether or not there is a record corresponding to the workflow name stored in the field of the target flow name of the record held in the workflow in operation in the workflow information 13a (step S106).

If there is a record corresponding to the workflow name stored in the field of the target flow name of the record held in the workflow in operation in the workflow information 13a (step S106 Yes), it is understood that the switching preparation for the old and new workflows has been prepared. In this case, the switching control unit 15e notifies stopping the workflow in operation and starting the workflow for updating, that is to say, the switching instruction of the old and new workflows to the WF execution unit 15b (step S107).

The WF execution unit 15b receives the instruction and automatically registers the new workflow, that is to say, the schedule regarding the workflow for updating to the schedule information 13b (step S108).

Further, the WF execution unit 15b converts the binary file of the new workflow included in the workflow information 13a into the XML format and loads the file into the internal memory not illustrated in FIG. 4 so as to start the workflow for updating (step S109). At the same time or about that time, the WF execution unit 15b stops the workflow to be replaced by the workflow for updating, that is to say, the old workflow (step S110). Based on this, the WF execution unit 15b updates the contents of the record corresponding to the old workflow out of the schedule information 13b stored in the storage unit 13 (step S111).

On the other hand, in step S105, if the field of the target flow name has a NULL value (step S105 No), it is understood that a new workflow to be used for updating the workflow in operation is not registered. If there is not a record corresponding to the workflow name stored in the field of the target flow name of the record held in the workflow in operation in the workflow information 13a (step S106 No), it is understood that the information regarding the new workflow is artificially, logically, or physically corrupted, and switching preparation of the old and new workflows has not been prepared. If determined as No in step S105 or No in step S106, the processing of step S107 and after that are skipped and the processing proceeds to step S112.

After that, until the processing step executed in accordance with the procedure defined by the workflow meets the termination condition (step S112 No), the processing of the above-described steps S102 to step S111 is repeatedly executed. When the processing step executed in accordance with the procedure defined by the workflow meets the termination condition (step S112 Yes), the processing is terminated.

As described above, if determined that there is a new workflow while executing a workflow including a switching point API that determines whether or not there is a new workflow to be used for updating an old workflow, the WF execution server 10 according to the present embodiment starts a new workflow and stops an old workflow. Accordingly, when a workflow in which repetition processing, namely a so-called loop processing is defined is executed, it is possible to reduce the occurrence of the operation by a system administrator, or the like to stop the workflow in operation at the stage of the processing step in which a problem is unlikely to occur, and further to reduce the operation to confirm the stop of the workflow in operation and then to start the workflow for updating. Further, if stopping the old workflow is carried out later than the starting a new workflow, it is possible to remove the time difference from stopping the old workflow to starting a new workflow.

Thereby, it is possible for the WF execution server 10 according to the present embodiment to smoothly switch old and new workflows. In addition, the operation by a network administrator, or the like become unused, and the non-stop operation of the system to be monitored is realized so that it is possible to smoothly carry out a logic change, such as changing the threshold value of bandwidth monitoring in the network monitoring.

### Second Embodiment

A description has been given of the device according to the embodiment of the disclosure. However, the present disclosure may be carried out by various modes other than the above-described embodiment. Thus, following, a description will be given of the other embodiments included in the present disclosure.

Each component of each device illustrated in the figures does not have to be physically configured as illustrated in the figures. That is to say, a specific mode of distribution and integration of each device is not limited to the configuration illustrated in the figures. It is possible to configure all of or a part of each device by functionally or physically distributing or integrating the device in any units in accordance with the various loads, use states, and the like. For example, the registration unit 15a, the WF execution unit 15b, the first API execution unit 15c, the second API execution unit 15d, or the switching control unit 15e may be coupled via a network as an external device of the WF execution server 10. Each of the registration unit 15a, the WF execution unit 15b, the first API execution unit 15c, the second API execution unit 15d or the switching control unit 15e may be included in a separate device and may cooperate with one another by being coupled to a network in order to realize the functions of the WF execution server 10 described above. All of or a part of the workflow information 13a and the schedule information 13b that are stored in the storage unit 13 may have a separate device and may cooperate with one another by being coupled to a network in order to realize the functions of the WF execution server 10 described above.

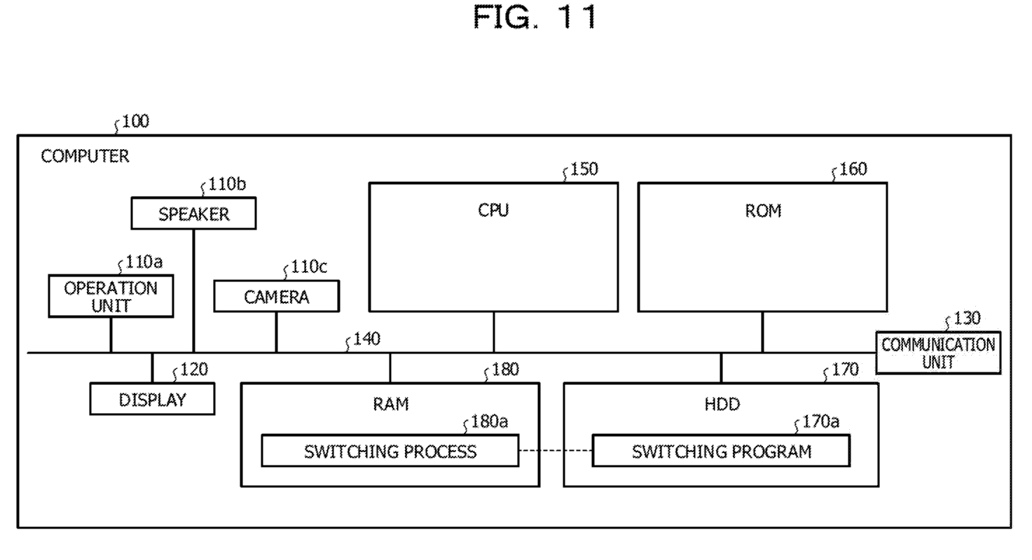

It is possible to realize the various kinds of processing described in the above embodiments by executing the program provided in advance on a computer, such as a personal computer, a workstation, or the like. Thus, a description will be given below of an example of a computer that executes a switching program that has the same functions as those of the embodiments described above using FIG. 11.

FIG. 11 is a diagram illustrating an example of a hardware configuration of a computer that executes the switching program according to the first embodiment and the second embodiment. As illustrated in FIG. 11, a computer 100 includes an operation unit 110a, a speaker 110b, a camera 110c, a display 120, and a communication unit 130. Further, the computer 100 includes a CPU 150, a ROM 160, an HDD 170, and a RAM 180. Each of the units 110 to 180 are coupled via a bus 140.

As illustrated in FIG. 11, the HDD 170 stores a switching program 170a that performs the same functions as those of the registration unit 15a, the WF execution unit 15b, the first API execution unit 15c, the second API execution unit 15d, and the switching control unit 15e that are illustrated in the first embodiment. The switching program 170a may be integrated or separated in the same manner as each component of the registration unit 15a, the WF execution unit 15b, the first API execution unit 15c, the second API execution unit 15d, and the switching control unit 15e that are illustrated in FIG. 4. That is to say, the HDD 170 does not have to store all the data illustrated in the first embodiment described above. The data used by the processing may be stored in the HDD 170.

Under such an environment, the CPU 150 reads the switching program 170a from the HDD 170 and loads the program in the RAM 180. As a result, as illustrated in FIG. 11, the switching program 170a functions as a switching process 180a. The switching process 180a loads various kinds of data read from the HDD 170 in the area allocated to the switching process 180a out of the storage area held by the RAM 180, and executes various kinds of processing using the various kinds of data. For example, as an example of the processing executed by the switching process 180a, the processing illustrated in FIG. 10, or the like is included. The CPU 150 does not have to operate all the processing unit illustrated in the first embodiment described above, and a processing unit corresponding to the processing to be executed ought to be virtually realized.

The switching program 170a described above does not have to be stored in the HDD 170 or the ROM 160 from the beginning. For example, the switching program 170a is stored in a “portable physical medium”, such as a flexible disk to be inserted into the computer 100, a so-called FD, a CD-ROM, a DVD disc, a magneto-optical disc, an IC card, or the like. The computer 100 may obtain the switching program 170a from these portable physical media and execute the program. The switching program 170a may be stored in another computer or a server device, or the like, which is coupled to the computer 100 via a public line, the Internet, a LAN, a WAN, or the like, and the computer 100 may obtain the switching program 170a from these and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-implemented method of processing information executed by a processor included in an information processing apparatus, the method comprising:
executing, with the processor, a first workflow including a determination processing to determine whether there is a second workflow to be used after the first workflow;
determining whether there is the second workflow in the determination processing;
switching from the first workflow to the second workflow by starting the second workflow and terminating the first workflow, when determining that there is the second workflow; and
providing the second workflow to a terminal device.

2. The computer-implemented method of processing information according to claim 1,
wherein the determining includes determining whether the second workflow corresponding to the first workflow is registered in workflow information storing a workflow before the switching and a workflow after the switching in association with each other.

3. The computer-implemented method of processing information according to claim 1,
wherein the switching includes terminating the first workflow after starting the second workflow.

4. The computer-implemented method of processing information according to claim 1, wherein the first workflow includes a plurality of processes, and the method further comprises:
executing the determination processing before executing loop processing to return to a processing which is already executed.

5. The computer-implemented method of processing information according to claim 4,
wherein the second workflow includes the loop processing.

6. The computer-implemented method of processing information according to claim 5,
wherein the second workflow includes a determination processing to determine whether there is a third workflow to be used after switching to the second workflow before the loop processing.

7. The computer-implemented method of processing information according to claim 1, wherein the method further comprises
executing the determination processing after waiting for a predetermined time period.

8. The computer-implemented method of processing information according to claim 1, further comprising:
installing the second workflow in a terminal device coupled to the information processing apparatus.

9. The computer-implemented method of processing information, according to claim 1,
wherein the switching includes switching using an application programming interface (API).

10. An information processing apparatus comprising:
a memory; and
a processor coupled to the memory and configured to:
load a first workflow specifying at least one computer process to be performed by the processor, the first workflow including a workflow switching point,
determine when a second workflow including at least one computer process is to be implemented by the processor, and
switch from the first workflow to the second workflow by starting the second workflow and terminating the second workflow based on the switching point when the processor determines there is a second workflow.

11. The information processing device according to claim 10, wherein the processor is further configured to
register each of a plurality of workflows received in a table stored in the memory,
review the table to determine if the second workflow is registered in the table before performing the switch,
perform the switch to the second workflow when the second workflow is registered.

12. The information processing device according to claim 11, wherein the processor is configured to not perform the switch when the second workflow is not registered.

13. The information processing device according to claim 12, wherein the processor is configured to identify the second workflow is at least one of artificially, logically or physically corrupted.

14. The information processing device according to claim 11, wherein
each of the first workflow and second workflow are used to monitor a bandwidth of Label Switched Paths (LSPs) set on an Optical Transport Network being monitored, and
the processor is further configured to
compare a bandwidth of the LSPs to a threshold, and
switch to the second workflow from the first work based on the comparison.

15. The information processing device according to claim 10, wherein the first workflow includes a plurality of computer processes, and
the processor is configured to terminate the first workflow during a computer process of the plurality of computer processes in which a problem is unlikely to occur.

16. The information processing apparatus according to claim 10, wherein the information processing apparatus is a workflow execution server.

17. The information processing apparatus according to claim 10, further comprising an interface configured to receive and transmit workflows to a terminal device.

18. A non-transitory computer-readable recording medium storing a program that causes a processor included in an information processing apparatus to execute a process, the process comprising:
executing a first workflow including a determination processing to determine whether there is a second workflow to be used after the first workflow;
determining whether there is the second workflow in the determination processing;
switching from the first workflow to the second workflow by starting the second workflow and terminating the first workflow, when determining that there is the second workflow; and
providing the second workflow to a terminal device.

19. The recording medium according to claim 18,
wherein the determining includes determining whether the second workflow corresponding to the first workflow is registered in workflow information storing a workflow before the switching and a workflow after the switching in association with each other.

20. The recording medium according to claim 18,
wherein the switching includes terminating the first workflow after starting the second workflow.
